(19) United States
(12) Patent Application Publication
(10) Pub. No.: US 2024/0359301 A1
(43) Pub. Date: Oct. 31, 2024

(54) DRIVER BIT

(71) Applicant: Makita U.S.A., Inc., La Mirada, CA (US)

(72) Inventors: Andrew CAMP, La Mirada, CA (US); Kenneth HEFLEY, La Mirada, CA (US); Nathan SANTOS, La Mirada, CA (US); Yeh Ching CHANG, TAICHUNG (TW)

(73) Assignee: Makita U.S.A., Inc., La Mirada, CA (US)

(21) Appl. No.: 18/141,434

(22) Filed: Apr. 30, 2023

(51) Int. Cl. B25B 23/00; B25B 21/00

(52) U.S. Cl. CPC B25B 23/0035; B25B 21/00

(57) ABSTRACT

Driver bits comprise a body, a tip disposed at proximal end of the body and configured to engage a faster, a shank disposed at distal end of the body and configured to fit into a power tool, a neck extending between the tip and the shank, and a torsion transfer section with one or more rings at distal end of the tip to absorb and transfer torque to torsion zone of the neck. The shank can also include one or more rings at proximal end of the shank to distribute impact force from the shank to the torsion zone of the neck.

This application claims priority to prior U.S. Design patent application Ser. No. 29/886,609, filed Mar. 10, 2023, and U.S. Design patent application Ser. No. 29/886,612, filed Mar. 10, 2023, the entire contents of which are incorporated herein by reference.

### BACKGROUND OF THE DISCLOSURE

### 1. Field of Disclosure

Generally, exemplary embodiments of the present disclosure relate to the field of devices for driver bits. Exemplary implementations of certain embodiments of the present disclosure provide novel features and combinations of features of various components of a driver bit to facilitate improvements in durability and functionality of such bits.

### 2. Discussion of the Background of the Disclosure

A driver bit is a device or a tool for driving screws, or other types of fasteners, that can be fitted to most driving power tools such as drills and/or impact drivers. Screws and fasteners typically have a head with a contour in which an appropriate driver tip can be engaged so that the application of sufficient torque to the driver bit will cause the fastener to rotate. Conventional driver bits have different types of shanks to fit different power tools and different tips to fit different fasteners, and various combinations of these features for different applications. One such bit type is known as a power driver bit (“power bit”) which is designed to fit into a chuck of a drill. Another bit type, which typically has an overall length of less than one inch is known as an insert bit (“insert bit”).

Since driver bits are subject to high impact and/or torque during repeated use, a need exists for improved driver bits that can withstand such operating conditions and maintain structural integrity for longer period of time.

### SUMMARY OF THE DISCLOSURE

Exemplary embodiments of the disclosure may address at least the above problems and/or disadvantages and other disadvantages not described above of conventional bits. Also, exemplary embodiments are not required to overcome the disadvantages described above, and may not overcome any of the problems described above.

Exemplary embodiments of the present disclosure provide a driver bit comprising a body, a tip disposed at a proximal end of the body and configured to engage a fastener, a shank disposed at a distal end of the body and configured to fit into a power tool, a neck extending between the tip and the shank, and a torsion transfer section comprising one or more proximal rings configured at a distal end of the tip and adjacent to a proximal end portion of the neck. The one or more proximal rings can be further configured to absorb and transfer torque, experienced at least at a proximal portion of said tip engaging said fastener during driving of said fastener, to at least a portion of said neck.

According to other and further exemplary embodiments of the present disclosure, a proximal end potion of the shank adjacent to a distal portion of the neck can comprise one or more distal rings, where the one or more distal rings can be configured to distribute impact force from the shank to at least a portion of the neck.

According to an exemplary implementation, a proximal end potion of the shank can comprise a cone shape base.

According to another exemplary implementation, the shank can comprise a power groove disposed toward a distal end of the driver bit body and configured to fit into and be engaged within a chuck of a power tool.

According to yet another exemplary implementation, the proximal end potion of the shank can comprises two or three distal rings.

According to further exemplary embodiments of the present disclosure, the torsion transfer section can comprise two proximal rings. In an exemplary implementation, a groove can be provided between the two proximal rings. In a further exemplary implementation, an exterior diameter of at least one of the two proximal rings can be greater than an outer diameter of the tip.

According to another further exemplary embodiment of the present disclosure, the torsion transfer section can comprise a single proximal ring. In an exemplary implementation, the torsion transfer section can further comprise a valley configured adjacent to the single proximal ring, between the single proximal ring and the proximal portion engaging the fastener. In a further exemplary implementation, an exterior diameter of the single proximal ring can be greater than an outer diameter of the tip.

According to an exemplary implementation of the present disclosure, at least a portion of the neck can have a smaller diameter than both the tip and the shank, or at least one of the tip and the shank.

In yet further exemplary implementation of exemplary embodiments of the present disclosure, a proximal end potion of the shank can comprises a cone shape base, and two or three distal rings can be configured to extend from a surface of the cone shape base by the same amount such that exterior diameters of the two or three distal rings essentially follow a cone shape profile of the cone shape base.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein

FIGS. 1A, 1B, and 1C illustrate rear prospective view, front prospective view, and side view, respectively, of an exemplary embodiment of the disclosure.

FIGS. 2A, 2B, and 2C illustrate rear prospective view, front prospective view, and side view, respectively, of another exemplary embodiment of the disclosure.

FIGS. 3A, 3B, and 3C diagrammatically illustrate generic applicability of features of exemplary implementations of exemplary embodiments of the disclosure.

FIGS. 4A, 4B, and 4C illustrate front prospective view, rear prospective view, and side view, respectively, of another exemplary embodiment of the disclosure.

FIGS. 5A, 5B, and 5C illustrate front prospective view, rear prospective view, and side view, respectively, of another exemplary embodiment of the disclosure.

FIGS. 6A, 6B, and 6C illustrate side views of yet further exemplary implementations of various exemplary embodiments of the disclosure.

FIGS. 7A, 7B, 7C and 7D each illustrate front view and side view of still further exemplary implementations of respective various exemplary embodiments of the disclosure.

FIGS. 8A, 8B, and 8C illustrate rear prospective view, front prospective view, and side view, respectively, of a further exemplary embodiment of the disclosure.

FIGS. 9A, 9B, and 9C illustrate rear prospective view, front prospective view, and side view, respectively, of another further exemplary embodiment of the disclosure.

FIGS. 10A, 10B and 10C diagrammatically illustrate generic applicability of features of exemplary implementations of exemplary embodiments of the disclosure.

FIGS. 11A, 11B, and 11C illustrate front prospective view, rear prospective view, and side view, respectively, of another further exemplary embodiment of the disclosure.

FIGS. 12A, 12B, and 12C illustrate front prospective view, rear prospective view, and side view, respectively, of another further exemplary embodiment of the disclosure.

FIGS. 13A, 13B, and 13C illustrate side views of yet further exemplary implementations of various further exemplary embodiments of the disclosure.

FIGS. 14A, 14B, 14C and 14D each illustrate front view and side view of still further exemplary implementations of respective various further exemplary embodiments of the disclosure.

### DETAILED DESCRIPTION OF EXEMPLARY EMBODIMENTS

Reference will now be made in detail to example embodiments which are

illustrated in the accompanying drawings, wherein like reference numerals refer to like elements throughout. In this regard, the example embodiments may have different forms and may not be construed as being limited to the descriptions set forth herein.

It will be understood that the terms “include,” “including”, “comprise, and/or “comprising,” when used in this specification, specify the presence of stated features, integers, steps, operations, elements, and/or components, but do not preclude the presence or addition of one or more other features, integers, steps, operations, elements, components, and/or groups thereof.

It will be further understood that, although the terms “first,” “second,” “third,” etc., may be used herein to describe various elements, components, regions, layers and/or sections, these elements, components, regions, layers and/or sections may not be limited by these terms. These terms are only used to distinguish one element, component, region, layer or section from another element, component, region, layer or section.

Expressions of relational orientation, such as “upper,” “lower,” “inside,” “outside,” “proximal,” “distal”, “end,” “portion”, “part,” “section,” etc. which are used for explaining the structural positions of various components as described herein, are not absolute but relative. The orientation expressions are appropriate when the various components are arranged as shown in the figures, but should change accordingly when the positions of the various components in the figures change.

As used herein, the term “and/or” includes any and all combinations of one or more of the associated listed items. Expressions such as “at least one of,” when preceding a list of elements, modify the entire list of elements and do not modify the individual elements of the list.

Various terms are used to refer to particular system components. Different companies may refer to a component by different names—this document does not intend to distinguish between components that differ in name but not function.

Matters of these example embodiments that are obvious to those of ordinary skill in the technical field to which these example embodiments pertain may not be described here in detail.

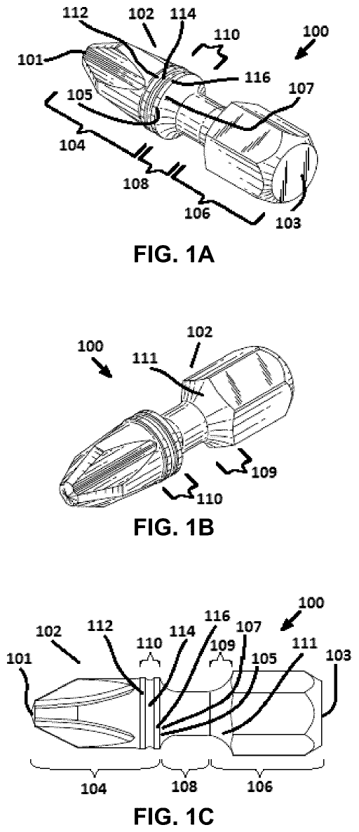

Referring to an example of FIGS. 1A-1C, exemplary implementations of exemplary embodiment of the present disclosure provide a driver bit 100, such as for example and without limitation an insert bit, comprising a body 102 that can comprise a tip 104 disposed at a proximate end 101 of body 102 for engaging a fastener (such a Phillips screw, as illustrated by way of an example and not a limitation), a shank 106 disposed at a distal end 103 of body 102, for example a rigid and/or solid and/or non-hollow body, that can fit into a power tool, such as a drill; and a neck 108 extending between the tip 104 and the shank 106. The driver bit 100 further comprises a torsion transfer section 110, which in an exemplary implementation can include one or more proximal rings, such as a first proximate ring, or rim, 112, and a second proximal ring 116, separated for example by an optional groove 114 that can be configured between first proximal ring 112 and second proximal ring 116.

According to an exemplary implementation, rings 112 and 116 are configured on a distal end 105 of tip 104 adjacent to proximal end portion 107 of neck 108. Rings 112 and 116 can be considered, by way of an illustrative naming and not as a limitation, as torsion power rings that can facilitate improved longevity of driver bit 100, for example by absorbing and transferring torque, experienced during operation of driver bit 100 at a proximal portion of tip 104 engaging a fastener (an operation such as driving or screwing the fastener), to torsion zone of neck 108.

According to another exemplary implementation, tip 104 can be a CNC machined tip that can give precision size and a better fit with fasteners, such as screws, for reducing cam-out force and better grip. In an exemplary implementation, rings 112 and 116 can be machined as part of tip 104.

According to yet another exemplary implementation, torsion zone geometry of neck 108 and/or its proximal end portion 107 can be optimized in consideration of torsion transfer section 110 for absorbing maximum impact force from power tools to facilitate protection of the fastener and life of the bit 100.

In an exemplary implementation, proximal end potion 109 of shank 106 can comprise a cone shape base 111 in communication with neck 108. And, in an exemplary implementation, shank 106 can be made by a uniquely calibrated heat-treating process for added durability, and/or can comprise matte nickel surface finish for unique, premium aesthetics, facilitating corrosion resistance and extending life of bit 100.

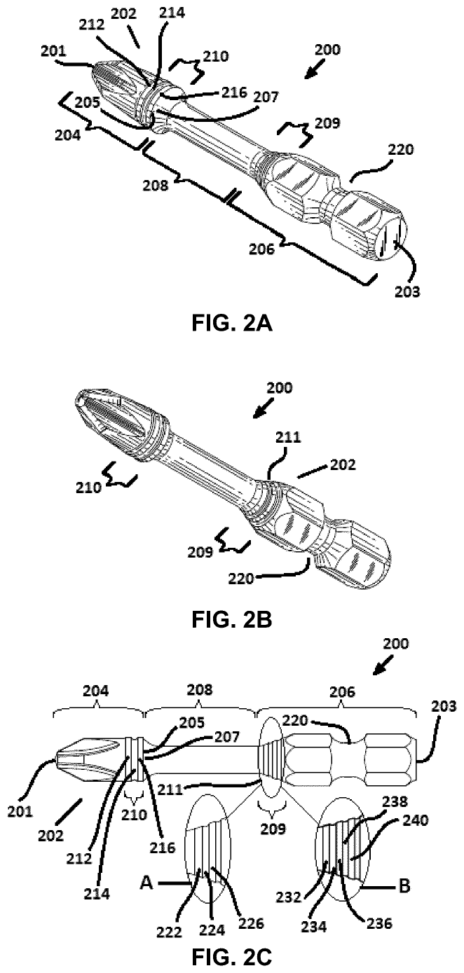

Referring to an example of FIGS. 2A-2C, exemplary implementations of another exemplary embodiment of the present disclosure provide a driver bit 200, such as for example and without limitation a power bit or an impact bit, comprising a body 202, for example a rigid and/or solid and/or non-hollow body, that can comprise a tip 204 disposed at a proximate end 201 of body 202 for engaging a fastener (such a Phillips screw, as illustrated by way of an example and not a limitation), a shank 206 disposed at a distal end 203 of body 202 that can fit into a power tool, such as a drill; and a neck 208 extending between the tip 204 and the shank 206. The driver bit 200 further comprises a torsion transfer section 210, which in an exemplary implementation can include one or more proximal rings, such as a first proximate ring, or rim, 212, and a second proximal ring 216, separated for example by an optional groove 214 that can be configured between first proximal ring 212 and second proximal ring 216.

Similar to exemplary embodiment of FIGS. 1A-1C, according to exemplary implementations illustrated in FIGS. 2A-2C, rings 212 and 216 are configured on a distal end 205 of tip 204 adjacent to proximal end portion 207 of neck 208. Rings 212 and 216 can be considered, by way of an illustrative naming and not as a limitation, as torsion power rings that can facilitate improved longevity of driver bit 200, for example by absorbing and transferring torque, experienced during operation of driver bit 200 at a proximal portion of tip 204 engaging a fastener (an operation such as driving or screwing the fastener), to torsion zone of neck 208. Tip 204 can be a CNC machined tip that can give precision size and a better fit with fasteners, such as screws, for reducing cam-out force and better grip. In an exemplary implementation, rings 212 and 216 can be machined as part of tip 204. Torsion zone geometry of neck 208 and/or its proximal end portion 207 can be optimized in consideration of torsion transfer section 210 for absorbing maximum impact force from power tools to facilitate protection of the fastener and life of the bit 200.

Unlike exemplary embodiment of FIGS. 1A-1C, according to an exemplary implementation of embodiment illustrated in FIGS. 2A-2C, shank 206 can include a power groove 220 configured toward a distal end 203 of body 202 to fit into, and be engaged within, a chuck of a power tool, such as a drill or an impact drill.

According to yet other exemplary implementations as illustrated in FIGS. 2A-2C, proximal end potion 209 of shank 206 adjacent to a distal portion of neck 208 can comprise one or more distal rings to distribute impact force from shank to torsion zone of neck 208 (for example, during an operation such as driving or screwing the fastener). As diagrammatically illustrated in the example of FIG. 2C, proximal end portion 209 can have a cone shape base 211 with: configuration A including a first distal ring 222 and a second distal ring 226, separated for example by an optional groove 224 that can be configured between first distal ring 222 and second distal ring 226; or configuration B including a first distal ring 232, a second distal ring 236, and a third distal ring 240 separated for example by an optional groove 234 that can be configured between first distal ring 232 and second distal ring 236, and another optional groove 238 that can be configured between second distal ring 236 and third distal ring 240.

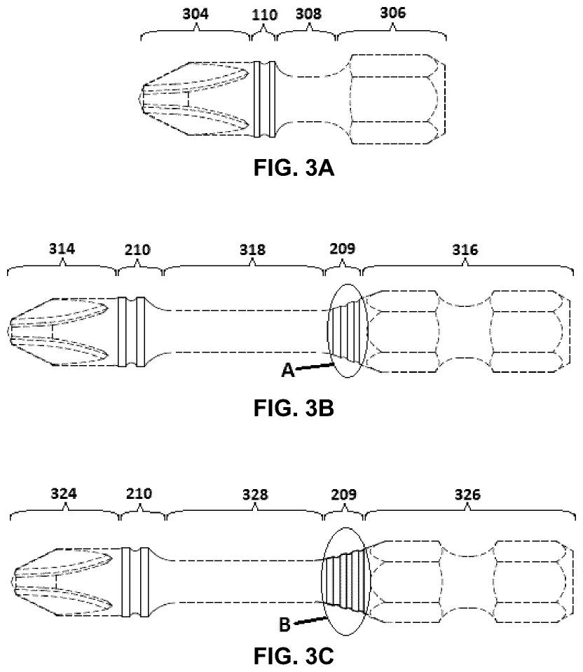

Examples of FIGS. 1A-1C and 2A-2C illustrate non-limiting examples of tips configured to fit fasteners with a head having crossed slots, which are commonly known as Phillips head screws, and certain relative sizes of neck and shank configurations. FIGS. 3A-3C diagrammatically illustrate, by means of broken lines signifying optional feature designs, that within exemplary embodiments of the disclosure are driver bits having proximal tip portions 304, 314, 324 configured for any types of fasteners, and having any neck 308, 318, 328 and shank 306, 316, 326 configurations, that can incorporate: a torsion transfer section 110 (see FIG. 3A, and for example, FIGS. 1A-1C); and/or a torsion transfer section 210 and a proximal end potion 209 having configuration A or B for distributing impact force from shank to torsion zone (see FIGS. 3B and 3C, and for example, FIGS. 2A-2C).

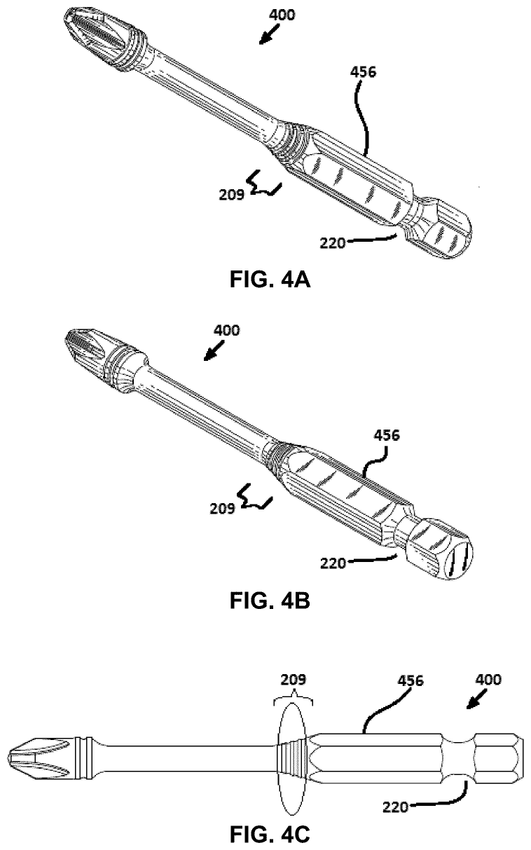

FIGS. 4A-4C illustrate an exemplary implementation where a drive bit 400 has essentially the same configuration as drive bit 200 of an embodiment illustrated in FIGS. 2A-2C, but the overall length of drive bit 400 has been increased by increasing the length of portion 456 of shank 206 between power grove 220 and proximal end portion 209.

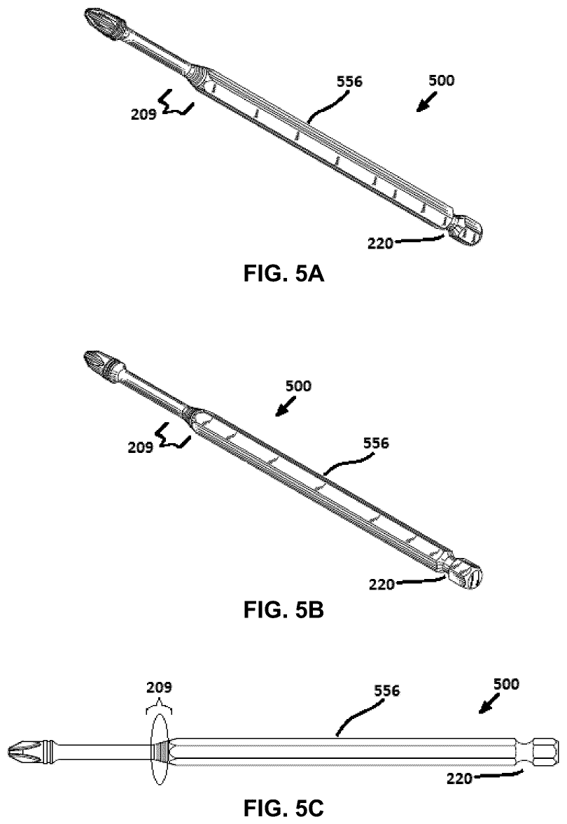

FIGS. 5A-5C illustrate an exemplary implementation where a drive bit 500 has essentially the same configuration as drive bit 200 of an embodiment illustrated in FIGS. 2A-2C and/or 400 of an embodiment illustrated in FIGS. 4A-4C, but the overall length of drive bit 500 has been further increased by increasing the length of portion 556 of shank 206 between power grove 220 and proximal end portion 209.

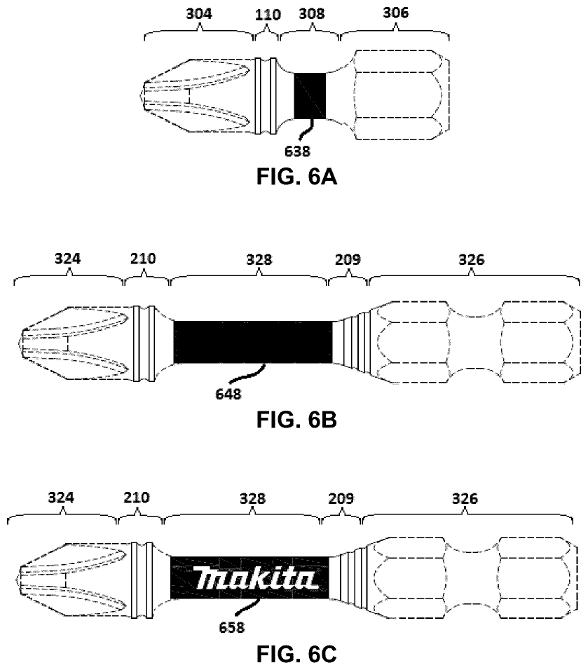

Further to FIGS. 3A-3C, FIGS. 6A-6C diagrammatically illustrate, by means of broken lines signifying optional feature designs, that within exemplary embodiments of the disclosure are driver bits having proximal tip portions 304, 314, 324 configured for any types of fasteners, and having any neck 308, 318, 328 and shank 306, 316, 326 configurations, that can further incorporate: a label 638, 648 and/or a design or logo 658 of any color either attached to exterior surface of neck 308, 318, 328 and/or formed on or with neck 308, 318, 328.

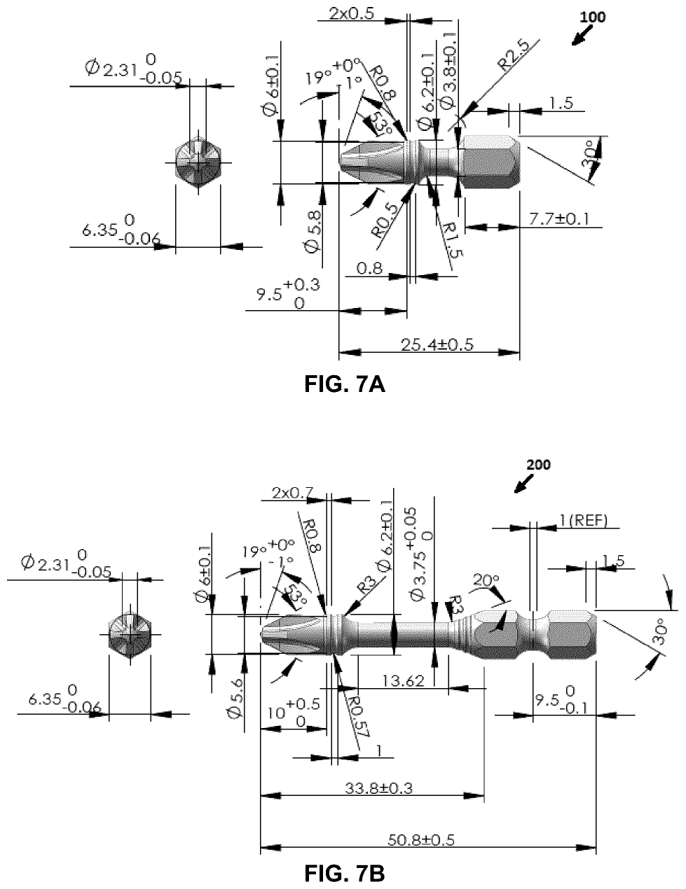

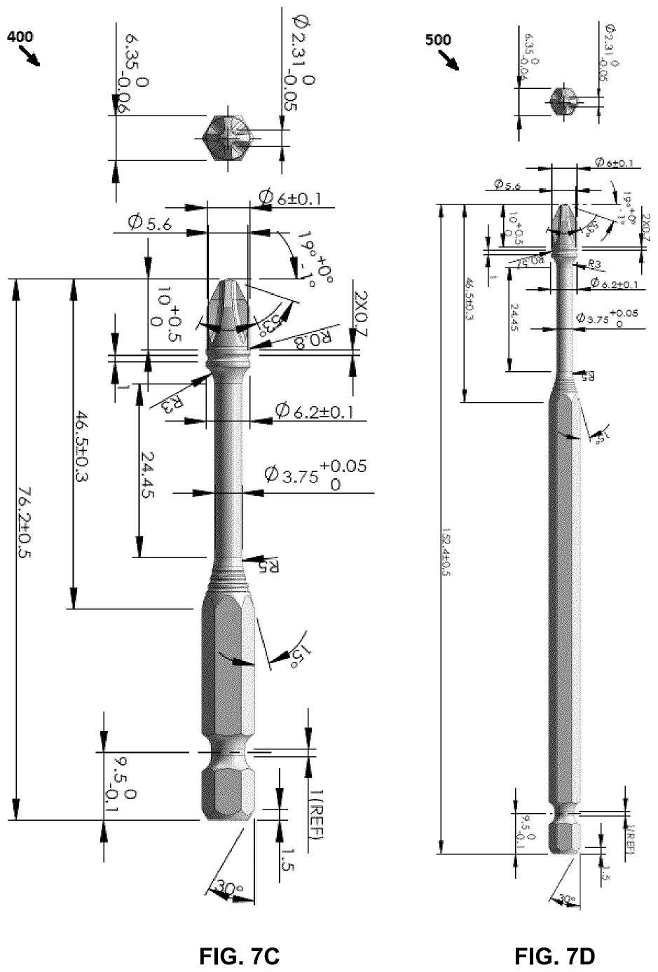

FIGS. 7A-7D show side view and front view with exemplary non-limiting engineering specifications for the structural features of exemplary embodiments of the disclosure as illustrated in FIGS. 1A-1C, 2A-2C, 4A-4C, and 5A-5C, respectively. Exemplary numerical values including relative dimensions and positions of various feature of drive bit 100 (FIG. 7A), drive bit 200 (FIG. 7B), drive bit 400 (FIG. 7C), and drive bit 500 (FIG. 7D) are provided as non-limiting examples of potential advantageous implementations of such bits in accordance with the present disclosure, which are all within the scope of the present disclosure as set forth in FIGS. 7A-7D and in various functional combinations.

As illustrated in non-limiting examples of FIGS. 7A-7D, exemplary implementation of disclosed embodiments can include any of the following features in any possible combinations: exterior diameter of tip 104, 204, 304, 314, 324 is smaller than exterior diameter of one or more rings 112, 212, 116, 216; at least a portion of shank 108, 208, 308, 318, 328 has a smaller diameter than tip 104, 204, 304, 314, 324 and/or shank 106, 206, 306, 316, 326; and or proximal end portion 109, 209 has a cone shape (such as cone shape base 211) tapering toward distal end of shank 106, 206, 306, 316, 326. In yet further exemplary implementation, rings 222, 226 and/or 232, 236, 238 can be configured to extend from a surface of cone shape base 211 by the same amount such that exterior diameters of rings 222, 226 and/or 232, 236, 238 essentially follow the cone shape profile of base 211.

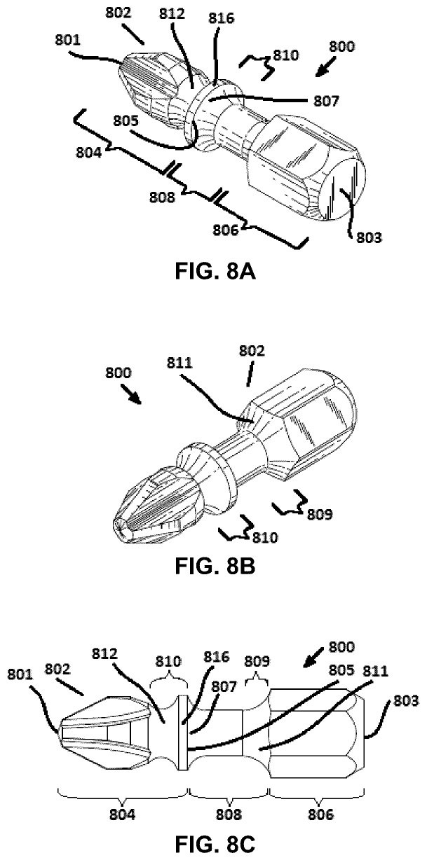

Referring to an example of FIGS. 8A-8C, exemplary implementations of further exemplary embodiments of the present disclosure provide a driver bit 800, such as for example and without limitation an insert bit, comprising a body 802, for example a rigid and/or solid and/or non-hollow body, that can comprise a tip 804 disposed at a proximate end 801 of body 802 for engaging a fastener (such a Phillips screw, as illustrated by way of an example and not a limitation), a shank 806 disposed at a distal end 803 of body 802 that can fit into a power tool, such as a drill; and a neck 808 extending between the tip 804 and the shank 806. The driver bit 800 further comprises a torsion transfer section 810, which in an exemplary implementation can include an annular valley 812 and a shoulder ring 816.

According to an exemplary implementation, shoulder ring 816 is configured on a distal end 805 of tip 804 adjacent to proximal end portion 807 of neck 808 and annular valley 812 is configured adjacent ring 816, between ring 816 and a proximal portion of tip 804 engaging a fastener. Valley 812 and ring 816 can be considered, by way of an illustrative naming and not as a limitation, as torque absorbing valley and ring that can facilitate improved longevity of driver bit 800, for example by absorbing and transferring torque, experienced during operation of driver bit 800 at a proximal portion of tip 804 engaging a fastener (an operation such as driving or screwing the fastener), to torsion zone of neck 408-808 and/or away from potential failure points of bit 800.

According to another exemplary implementation, tip 804 can be a CNC machined tip that can give precision size and a better fit with fasteners, such as screws, for reducing cam-out force and better grip. In an exemplary implementation, valley 812 and ring 816 can be machined as part of tip 804.

According to yet another exemplary implementation, torsion zone geometry of neck 808 and/or its proximal end portion 807 can be optimized in consideration of torsion transfer section 810 for absorbing maximum impact force from power tools to facilitate protection of the fastener and life of the bit 800.

In an exemplary implementation, proximal end potion 809 of shank 806 can comprise a cone shape base 811 in communication with neck 808. And, in an exemplary implementation, shank 806 can be made by a uniquely calibrated heat-treating process for added durability, and/or can comprise matte nickel surface finish for unique, premium aesthetics, facilitating corrosion resistance and extending life of bit 800.

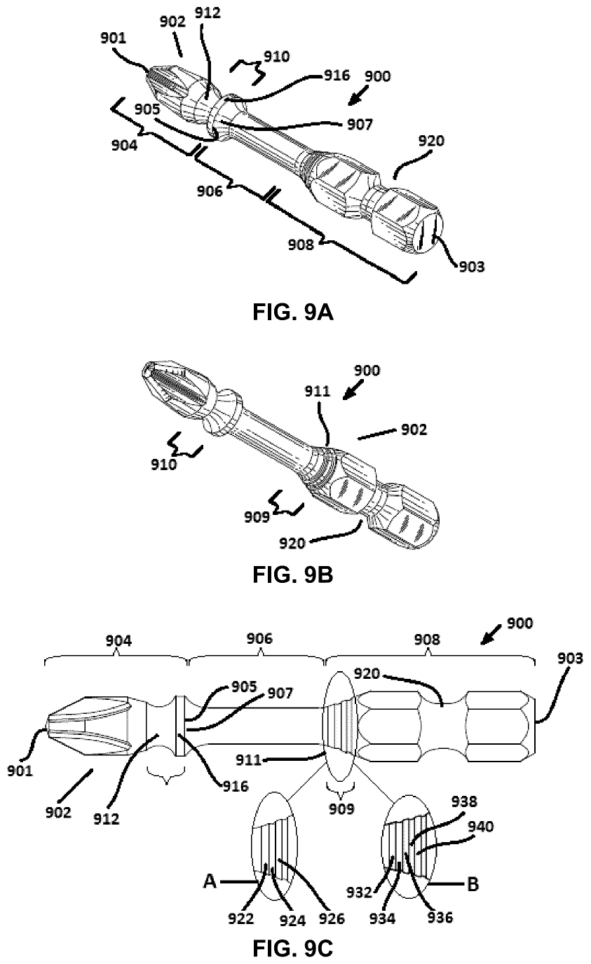

Referring to an example of FIGS. 9A-9C, exemplary implementations of another further exemplary embodiment of the present disclosure provide a driver bit 900, such as for example and without limitation a power bit or an impact bit, comprising a body 902, for example a rigid and/or solid and/or non-hollow body, that can comprise a tip 904 disposed at a proximate end 901 of body 902 for engaging a fastener (such a Phillips screw, as illustrated by way of an example and not a limitation), a shank 906 disposed at a distal end 903 of body 902 that can fit into a power tool, such as a drill; and a neck 908 extending between the tip 904 and the shank 906. The driver bit 900 further comprises a torsion transfer section 910, which in an exemplary implementation can include an annular valley 912 and a shoulder ring 916.

Similar to exemplary embodiment of FIGS. 8A-8C, according to exemplary implementations illustrated in FIGS. 9A-9C, shoulder ring 916 is configured on a distal end 905 of tip 904 adjacent to proximal end portion 907 of neck 908 and annular valley 912 is configured adjacent ring 916, between ring 916 and a proximal portion of tip 904 engaging a fastener. Valley 912 and ring 916 can be considered, by way of an illustrative naming and not as a limitation, as torque absorbing valley and ring that can facilitate improved longevity of driver bit 900, for example by absorbing and transferring torque, experienced during operation of driver bit 900 at a proximal portion of tip 904 engaging a fastener (an operation such as driving or screwing the fastener), to torsion zone of neck 908 and/or away from potential failure points of bit 900. Tip 904 can be a CNC machined tip that can give precision size and a better fit with fasteners, such as screws, for reducing cam-out force and better grip. In an exemplary implementation, valley 912 and ring 916 can be machined as part of tip 904. Torsion zone geometry of neck 908 and/or its proximal end portion 907 can be optimized in consideration of torsion transfer section 910 for absorbing maximum impact force from power tools to facilitate protection of the fastener and life of the bit 900.

Unlike exemplary embodiment of FIGS. 8A-8C, according to an exemplary implementation of embodiment illustrated in FIGS. 9A-9C, shank 906 can include a power groove 920 configured toward a distal end 903 of body 902 to fit into, and be engaged within, a chuck of a power tool, such as a drill or an impact drill.

According to yet other exemplary implementations as illustrated in FIGS. 9A-9C, proximal end potion 909 of shank 906 adjacent to a distal portion of neck 908 can comprise one or more distal rings to distribute impact force from shank to torsion zone of neck 908 (for example, during an operation such as driving or screwing the fastener). As diagrammatically illustrated in the example of FIGS. 9C, proximal end portion 909 can have a cone shape base 911 with: configuration A including a first distal ring 922 and a second distal ring 926, separated for example by an optional groove 924 that can be configured between first distal ring 922 and second distal ring 926; or configuration B including a first distal ring 932, a second distal ring 936, and a third distal ring 940 separated for example by an optional groove 934 that can be configured between first distal ring 932 and second distal ring 936, and another optional groove 938 that can be configured between second distal ring 936 and third distal ring 940.

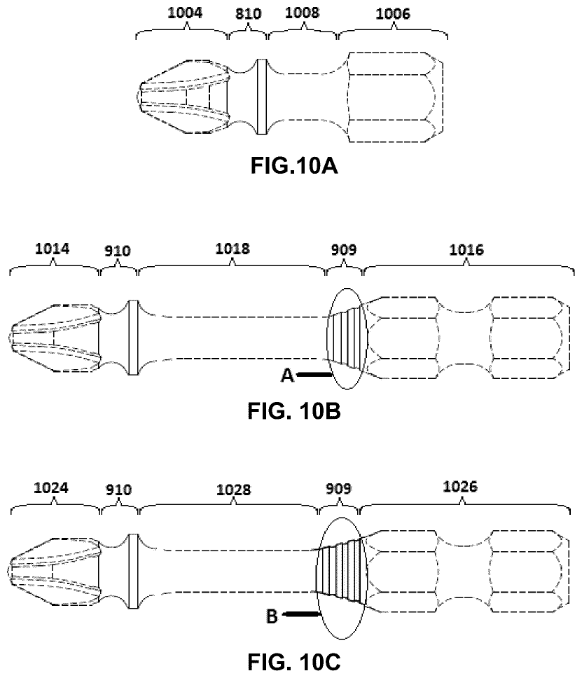

Examples of FIGS. 8A-8C and 9A-9C illustrate non-limiting examples of tips configured to fit fasteners with a head having crossed slots, which are commonly known as Phillips head screws, and certain relative sizes of neck and shank configurations. FIGS. 10A-10C diagrammatically illustrate, by means of broken lines signifying optional feature designs, that within exemplary embodiments of the disclosure are driver bits having proximal tip portions 1004, 1014, 1024 configured for any types of fasteners, and having any neck 1008, 1018, 1028 and shank 1006, 1016, 1026 configurations, that can incorporate: a torsion transfer section 810 (see FIG. 10A, and for example, FIGS. 8A-8C); and/or a torsion transfer section 910 and a proximal end potion 909 having configuration A or B for distributing impact force from shank to torsion zone (see FIGS. 10B and 10C, and for example, FIGS. 9A-9C).

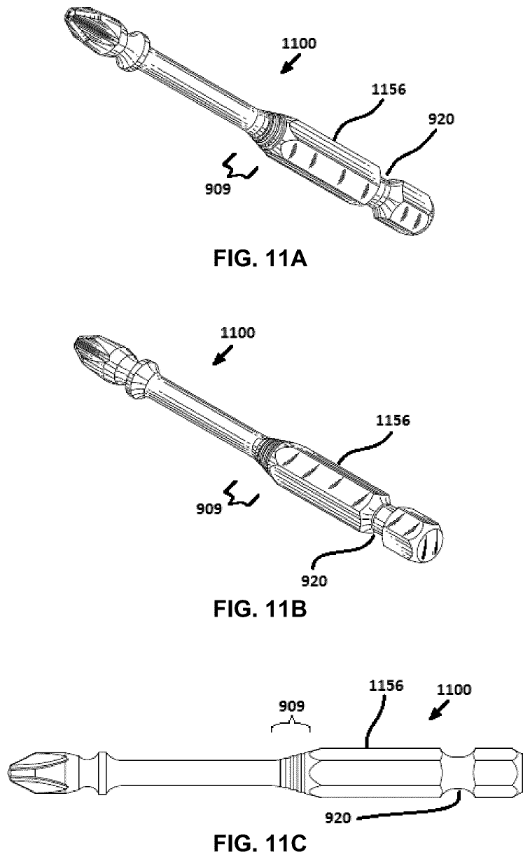

FIGS. 11A-11C illustrate an exemplary implementation where a drive bit 1100 has essentially the same configuration as drive bit 900 of an embodiment illustrated in FIGS. 9A-9C, but the overall length of drive bit 900 has been increased by increasing the length of portion 1156 of shank 906 between power grove 920 and proximal end portion 909.

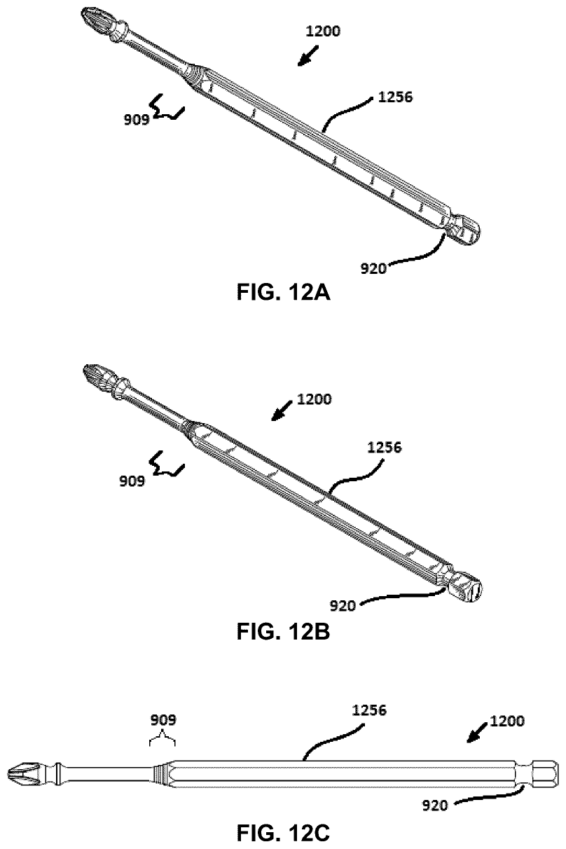

FIGS. 12A-12C illustrate an exemplary implementation where a drive bit 1200 has essentially the same configuration as drive bit 900 of an embodiment illustrated in FIGS. 9A-9C and/or 1100 of an embodiment illustrated in FIGS. 11A-11C, but the overall length of drive bit 1200 has been further increased by increasing the length of portion 1256 of shank 906 between power grove 920 and proximal end portion 909.

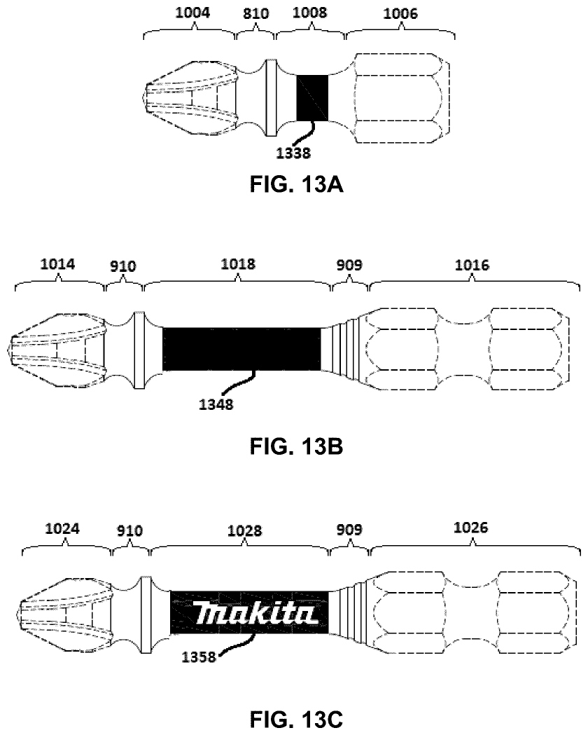

Further to FIGS. 10A-10C, FIGS. 13A-13C diagrammatically illustrate, by means of broken lines signifying optional feature designs, that within exemplary embodiments of the disclosure are driver bits having proximal tip portions 1004, 1014, 1024 configured for any types of fasteners, and having any neck 1008, 1018, 1028 and shank 1006, 1016, 1026 configurations, that can further incorporate: a label 1338, 1348 and/or a design or logo 1358 of any color either attached to exterior surface of neck 1008, 1018, 1028 and/or formed on or with neck 1008, 1018, 1028.

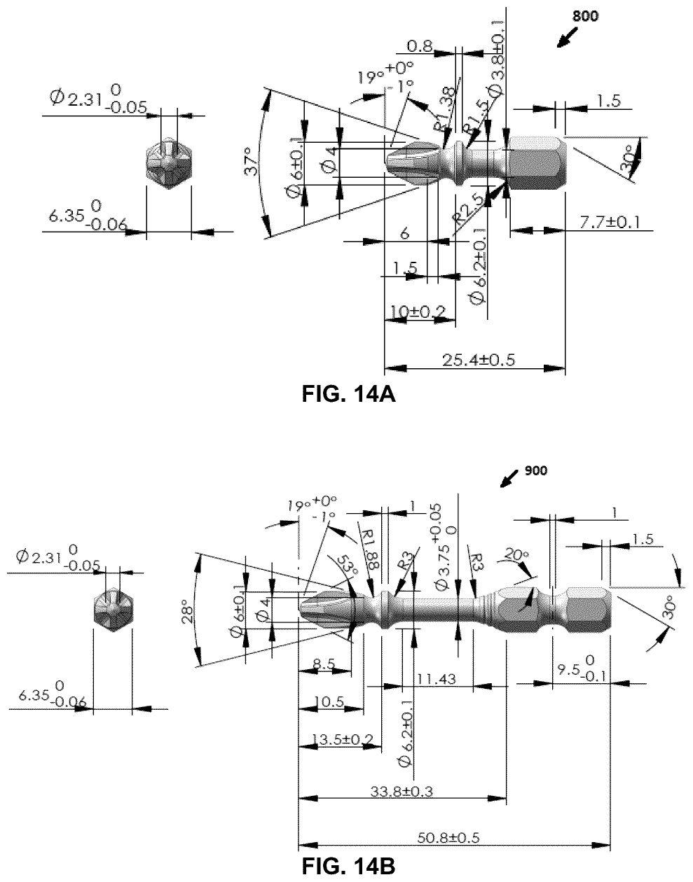

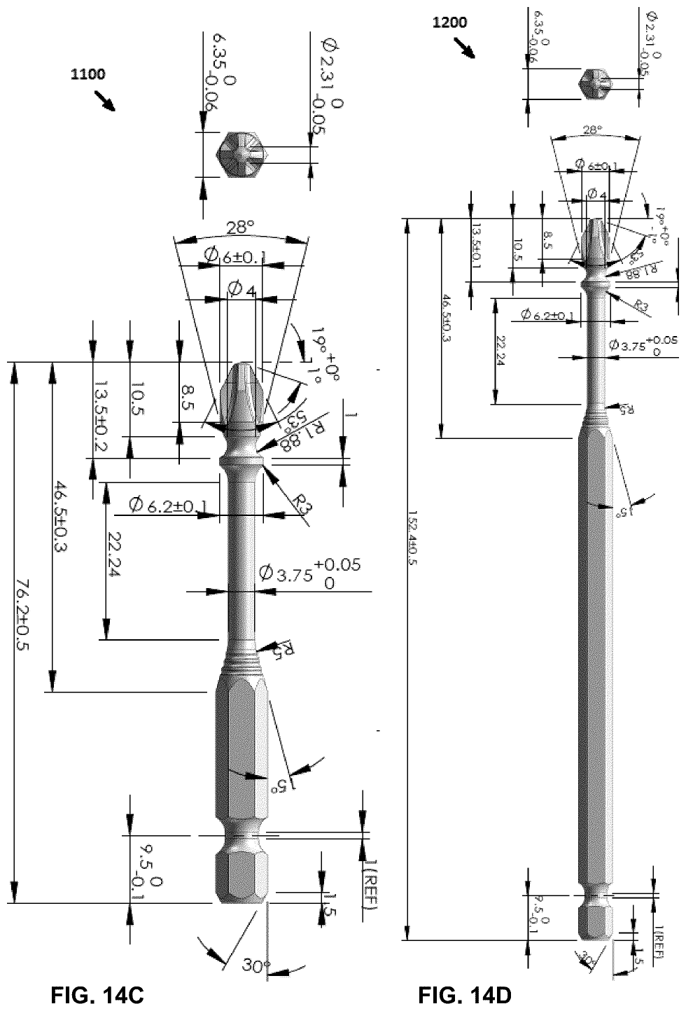

FIGS. 14A-14D show side view and front view with exemplary non-limiting engineering specifications for the structural features of exemplary embodiments of the disclosure as illustrated in FIGS. 8A-8C, 9A-9C, 11A-11C, and 12A-12C, respectively. Exemplary numerical values including relative dimensions and positions of various feature of drive bit 800 (FIG. 14A), drive bit 900 (FIG. 14B), drive bit 1100 (FIG. 14C), and drive bit 1200 (FIG. 14D) are provided as non-limiting examples of potential advantageous implementations of such bits in accordance with the present disclosure, which are all within the scope of the present disclosure as set forth in FIGS. 14A-14D and in various functional combinations.

As illustrated in non-limiting examples of FIGS. 14A-14D, exemplary implementation of disclosed disclose-embodiments can include any of the following features in any possible combinations: exterior diameter of tip 804, 904, 1004, 1014, 1024 is smaller than exterior diameter of ring 816, 916; valley 812, 912 can form a significant portion of tip 804,904, such as for example about 30% thereof; at least a portion of shank 808, 908, 1008, 1018, 1028 has a smaller diameter than tip 804, 904, 1004, 1014, 1024 and/or shank 806, 906, 1006, 1016, 1026; and or proximal end portion 809, 909 has a cone shape (such as cone shape base 911) tapering toward distal end of shank 806, 906, 1006, 1016, 1026. In yet further exemplary implementation, rings 922, 926 and/or 932, 936, 938 can be configured to extend from a surface of cone shape base 911 by the same amount such that exterior diameters of rings 922, 926 and/or 932, 936, 938 essentially follow the cone shape profile of base 911.

While the present disclosure has been shown and described with reference to certain exemplary embodiments thereof, it will be understood by those skilled in the art that various changes in form and details may be made therein without departing from the spirit and scope of the present disclosure.

Other objects, advantages and salient features of the disclosure will become apparent to those skilled in the art from the details provided, which, taken in conjunction with the annexed drawing figures, disclose exemplary embodiments of the disclosure.

The above-presented description and figures are intended by way of example only and are not intended to limit the illustrative embodiments in any way except as set forth in the appended claims. It is particularly noted that various technical aspects of the various elements of the various exemplary embodiments that have been described above can be combined in numerous other ways, all of which are considered to be within the scope of the disclosure.

Accordingly, although exemplary embodiments have been disclosed for illustrative purposes, those skilled in the art will appreciate that various modifications, additions, and substitutions are possible. Therefore, the disclosure is not limited to the above-described embodiments, but may be modified within the scope of appended claims, along with their full scope of equivalents.

1. A driver bit comprising:
a body;
a tip disposed at a proximal end of said body and configured to engage a faster;
a shank disposed at a distal end of said body and configured to fit into a power tool;
a neck extending between said tip and said shank; and
a torsion transfer section comprising one or more proximal rings configured at a distal end of said tip and adjacent to a proximal end portion of said neck,
said one or more proximal rings being further configured to absorb and transfer torque, experienced at least at a proximal portion of said tip engaging said fastener during driving of said fastener, to at least a portion of said neck.

2. The driver bit of claim 1, wherein a proximal end potion of said shank adjacent to a distal portion of said neck comprises one or more distal rings,
said one or more distal rings being configured to distribute impact force from said shank to at least a portion of said neck.

3. The driver bit of claim 2, wherein said proximal end potion of said shank comprises a cone shape base.

4. The driver bit of claim 2, wherein said shank comprises a power groove disposed toward a distal end of said body and configured to fit into and be engaged within a chuck of a power tool.

5. The driver bit of claim 2, wherein said proximal end potion of said shank comprises two distal rings.

6. The driver bit of claim 2, wherein said proximal end potion of said shank comprises three distal rings.

7. The driver bit of claim 1, wherein said torsion transfer section comprises a first proximal ring and a second proximal ring.

8. The driver bit of claim 7, wherein said torsion transfer section further comprises a groove between said first proximal ring and said second proximal ring.

9. The driver bit of claim 7, wherein an exterior diameter of at least one of said first proximal ring and second proximal ring is greater than an outer diameter of said tip.

10. The driver bit of claim 1, wherein said torsion transfer section comprises a single proximal ring.

11. The driver bit of claim 10, wherein said torsion transfer section further comprises a valley configured adjacent said single proximal ring, between said single proximal ring and said proximal portion engaging said fastener.

12. The driver bit of claim 10, wherein an exterior diameter of said single proximal ring is greater than an outer diameter of said tip.

13. The driver bit of claim 1, wherein at least a portion of said neck has a smaller diameter than said tip and said shank.

14. The driver bit of claim 5, wherein said proximal end potion of said shank comprises a cone shape base, and said two distal rings are configured to extend from a surface of said cone shape base by the same amount such that exterior diameters of said two distal rings essentially follow a cone shape profile of said cone shape base.

15. The driver bit of claim 6, wherein said proximal end potion of said shank comprises a cone shape base, and said three distal rings are configured to extend from a surface of said cone shape base by the same amount such that exterior diameters of said three distal rings essentially follow a cone shape profile of said cone shape base.
